(19) United States
(12) Patent Application Publication
(10) Pub. No.: US 2020/0034500 A1
(43) Pub. Date: Jan. 30, 2020

(54) A SENSOR PLACEMENT METHOD FOR CAPTURING STRUCTURAL LOCAL DEFORMATION AND GLOBAL MODAL INFORMATION

(71) Applicant: Dalian University of Technology, Dalian, Liaoning (CN)

(72) Inventors: Tinghua YI, Dalian, Liaoning (CN); Xueyang PEI, Dalian, Liaoning (CN); Hongnan LI, Dalian, Liaoning (CN)

(21) Appl. No.: 16/342,907

(22) PCT Filed: Mar. 19, 2018
(86) PCT No.: PCT/CN2018/079405

§ 371 Date: Apr. 17, 2019

(30) Foreign Application Priority Data
Jun. 26, 2017 (CN) 201710490407.0

(51) Int. Cl. G06F 17/50

(52) U.S. Cl. CPC G06F 17/5004; G06F 2217/16; G06F 17/5018

(57) ABSTRACT

Sensor placement for structural health monitoring relating to modal estimation of bridge structures using structural data from strain gauges and accelerometers. Arrange strain gauges at large deformation positions of the structure for monitoring local deformation information. Adjust positions of strain gauges to include as much important displacement modal information as possible. Use strain mode shapes of strain gauge positions to estimate the displacement mode shapes of the structure and increase accelerometer to improve distinguishability of estimated displacement mode shapes, while reducing redundancy information among obtained displacement mode shapes. Different structural information contained in the strain gauges and the accelerometers are used, and placement of strain gauges can give local deformation information of key positions of the structure and obtain accurate structural displacement modal information. Placement of accelerometers improves displacement modal information obtained by estimation of strain mode shapes, and high-quality structural overall displacement modal information is obtained.

### TECHNICAL FIELD

The presented invention belongs to the technical field of sensor placement for structural health monitoring, and relates to the acquisition of structural local deformation and global modal information from the strain gauges and the accelerometers.

### BACKGROUND

The establishment of structural health monitoring system first needs to select and optimize the placement of sensors. Inappropriate sensor placement will affect the accuracy of parameter identification. The sensor itself also needs a certain cost, and the cost of the data acquisition and processing equipment is expensive. From an economic perspective, engineers want to use as few sensors as possible for monitoring purposes. A good sensor placement should satisfy: (1) in a noisy environment, it is possible to obtain comprehensive and accurate structural parameter information using few sensors; (2) the measured structural response information should be able to correlate with the results of the numerical analysis; (3) the vibration response data of interest can be collected with emphasis by rationally adding sensors; (4) the monitoring results have good visibility and robustness; (5) make the cost of making equipment input, data transmission and result processing of the monitoring system be small.

In a complete structural health monitoring system, strain gauges and accelerometers are used in large quantities. It is of great practical value to study the sensor placement method for obtaining as much structural information as possible by using a small number of different types of sensors.

### SUMMARY

In the proposed invention, the strain gauge and the accelerometer locations are jointly optimized to simultaneously acquire local deformation information and global modal information of the structure. The selection of the strain gauge locations not only requires the consideration of large deformations of the structure, but also requires that the selected locations contain enough displacement modal information. The obtained strain modes are used to estimate the structural displacement modes at other locations, and the accelerometers are then added to the sensor placement according to the modal confidence criterion and the modal information redundancy. The acquired displacement modes from the strain gauges and accelerometers are distinguishable and contain little information redundancy.

The procedures of the sensor placement method are as follows:

1. Selection of the strain gauge locations.

In structural health monitoring systems, strain gauges are primarily used to monitor local deformation information of structures, so they need to be placed where large deformations occur in the structure. For example, in the bridge structure, the strain gauges need to be placed at the mid-section positions.

Step 1.1: According to the finite element method, the structure is divided into individual elements, and the elements and nodes are numbered. The sections with large structural deformations are selected as the candidate positions of the strain gauges. For the ith element, the relationship between the strain mode shape and the nodal displacement mode shape is obtained.

φᵢ=Tᵢϕᵢ (1)

where: the subscript i indicates the number of the element; φᵢ is the strain mode shape matrix corresponding to the strain gauge locations in the ith element; ϕᵢ is the nodal displacement mode shape matrix of the ith element, which contains translational displacement modal and rotational displacement modal in three directions; Tᵢ is the translation matrix which represents the relationship between the strain mode shape and the nodal displacement mode shape in the ith element.

Each row of Tᵢ corresponds to one row of the strain mode shape matrix, which corresponds to a strain gauge location; each column of Tᵢ corresponds to one row of the displacement mode shape matrix, which corresponds to one degree of freedom of the nodal displacement. Therefore, the amount of displacement modal information of each degree of freedom contained in the strain gauge locations is determined by the magnitude of variables in Tᵢ. When a certain variable in Tᵢ is 0, it means that the displacement modal information at the degree of freedom corresponding to this variable is not included in the strain mode at the strain gauge location.

In the structural modal test, because the translational displacement mode is widely used, the selected strain gauge locations need to contain sufficient translational displacement modal information. Therefore, it is necessary to guarantee that the corresponding variable values cannot be small. The strain gauges placed at the mid-sections are adjusted to make the corresponding variable values in Tᵢ large enough. Finally, the positions of the S1 strain gauges are determined.

Step 1.2: According to the element number of the strain section positions obtained in step 1.1, the value of each variable in the matrix Tᵢ is checked according to Eq.(1). If the variable value is too small, fine tune the strain position to include as much displacement modal information as possible.

The strain gauge locations obtained by steps 1.1 and 1.2 can guarantee that the monitoring positions contain sufficient structural deformation information. In addition, the monitoring positions contain as much structural displacement modal information as possible, which is very advantageous for the acquisition of the structural displacement modal information.

From Eq. (1), the relationship between the strain mode shapes at all strain gauge locations in the structure and the displacement mode shapes at all nodes of the finite model can be derived.

φ=Tϕ (2)

where φ is the strain mode shape matrix of the strain gauge locations; ϕ is the nodal displacement mode shape matrix of the structure according to the FE model; T is the transformation matrix.

The strain mode shapes corresponding to the strain gauge locations can be calculated from the strain data. Due to the limitation of the number of strain gauges, the number of rows of φ is smaller than the number of rows of ϕ, so that it is not feasible to directly estimate the displacement mode shapes of all nodes by the strain mode shapes. At this time, only the displacement mode shapes of some nodes can be estimated. Here, ϕ^{r} is the displacement mode shape matrix which can be estimated, with r representing the degrees of freedom corresponding to the selected displacement mode shapes.

Step 1.3: Eq. (2) can be further written as:

φ=T^{r}ϕ^{r}+T^{n-r}ϕ^{n-r} (3)

where: T^{r} represents the r columns of T corresponding to the selected displacement mode shapes; T^{n-r} consists of the remaining n−r columns of T; ϕ^{n-r} consists of the remaining n−r rows of ϕ; n represents the number of the rows of ϕ, which is also the number of the columns of T.

In actual engineering, the strain mode shapes calculated by the strain data sometimes differ from the actual strain mode shapes of the structure, that is, there is a certain error. The source of error is mainly indicated by the measurement noise and the structural model error. Thus, Eq. (3) can be further written as:

φ=T^{r}ϕ^{r}+T^{n-r}ϕ^{n-r}+w (4)

where: w represents the error, which is expressed as stationary Gaussian noise, in which each column of w is also a stationary Gaussian vector w₍ᵢ₎. w₍ᵢ₎ has a mean of zero, and the covariance matrix is Cov(w₍ᵢ₎)=σᵢI, in which I is the unit matrix.

Step 1.4: When the number of rows of T^{r} is greater than the number of columns of T^{r}, the multiplicative multiple least squares method can be used to estimate the displacement mode shapes (ϕ^{r}).

\tilde{ϕ}^{r}=(T^{r}T^{r})⁻¹T^{rT}(φ−T^{n-r}ϕ^{n-r}) (5)

where: \tilde{ϕ}^{r} is the estimation result of ϕ^{r}.

Each column of \tilde{ϕ}^{r} can be expressed as:

\tilde{ϕ}₍ᵢ₎^{r}=(T^{r}T^{r})⁻¹T^{rT}(φ₍ᵢ₎−T^{n-r}ϕ₍ᵢ₎^{n-r}) (6)

where: the subscript i indicates the ith column of the corresponding matrix. From Eq. (6), the covariance matrix of \tilde{ϕ}₍ᵢ₎^{r} can be written as:

Cov(\tilde{ϕ}₍ᵢ₎^{r)=σ}ᵢ²(T^{rT}T^{r})⁻¹ (7)

Step 1.5: Each diagonal element in the covariance matrix Cov(\tilde{ϕ}₍ᵢ₎^{r}) indicates the estimation errors of the estimated displacement mode shapes corresponding to each degree of freedom. The trace of the covariance matrix Cov(\tilde{ϕ}₍ᵢ₎^{r}) can be used to represent the magnitude of the estimation error.

error (\tilde{ϕ}₍ᵢ₎^{r})=σᵢtrace({square root over (T^{rT}T^{r})⁻¹)}) (8)

where: error(\tilde{ϕ}₍ᵢ₎^{r}) represents the estimation error of \tilde{ϕ}₍ᵢ₎^{r}.

Then, the estimation error of \tilde{ϕ}^{r} consists of the estimation errors of different columns of \tilde{ϕ}^{r}.

$$error ( {\tilde{Φ}}^{r} ) = {\sum }_{i = 1}^{N} {σ}_{i} trace ( \sqrt{{( {T}^{rT} {T}^{r} )}^{- 1}} ) \qquad ( 9 )$$

where: N is the number of the columns of \tilde{ϕ}^{r}, which is also the number of the mode orders.

When σᵢ of different mode orders have the same value, the Eq. (9) can be further written as:

error(\tilde{ϕ}^{r})∝trace({square root over (T^{rT}T^{r})⁻¹)}) (10)

It can be seen from Eq. (10) that the value of error(\tilde{ϕ}^{r}) is mainly determined by T^{r}. Different transformation matrices T^{r} correspond to different locations of the estimated displacement mode shapes. Finally, the T^{r} corresponding to the minimum estimation error is determined, and the displacement mode shapes of the locations corresponding to the determined T^{r} are estimated.

2. Selection of the accelerometer locations.

The structural displacement mode shapes obtained from the structural health monitoring system need to be distinguishable. Therefore, the modal confidence criterion (MAC) is used here to measure the distinguishability of obtained displacement mode shapes. The MAC matrix can be expressed as:

$${MAC}_{i , j} = \frac{{( {Φ}_{* , i}^{T} {Φ}_{* , j} )}^{2}}{( {Φ}_{* , i}^{T} {Φ}_{* , i} ) ( {Φ}_{* , j}^{T} {Φ}_{* , j} )} \qquad ( 11 )$$

where MAC_{i,j} is the element at the ith row and jth column of the MAC matrix; ϕ_{*,j} and ϕ_{*,j} are the ith and jth column of the displacement mode shape matrix. If the value of MAC_{i,j} is close to 0, it means that the two mode shape vectors are easy to distinguish; if the value of MAC_{i,j} is close to 1, it means that the two mode shape vectors are not easily distinguishable. In actual engineering, it is necessary to guarantee that the values of the variables in the MAC matrix are as small as possible, generally less than 0.2.

Considering the continuity of the modal shapes, once the locations of two sensors are too close, the displacement modal information contained in these two locations will have a high degree of similarity. The Frobenius norm is used here to calculate the information redundancy between sensors:

$${γ}_{i , j} = 1 - \frac{{‖ {Φ}_{3 i} - {Φ}_{3 j} ‖}_{F}}{{‖ {Φ}_{3 i} ‖}_{F} + {‖ {Φ}_{3 j} ‖}_{F}} \qquad ( 12 )$$

where γ_{i,j} is the redundancy coefficient between ith and jth accelerometer locations. When γ_{i,k} is close to 1, it means that the displacement modal information of two locations is very similar. At this point, it is not necessary for these two locations to exist at the same time, and a location needs to be deleted. In actual operation, an appropriate redundancy threshold h can be set. If the redundancy coefficient is greater than the redundancy threshold h, the corresponding measurement point position will be deleted.

Step 2.1: Set a redundancy threshold value h.

Step 2.2: Calculate the redundancy coefficients of the estimated displacement mode shapes (\tilde{ϕ}^{r}) and the displacement mode shapes of residual candidate accelerometer locations. If one redundancy coefficient is greater than h, the corresponding candidate accelerometer location is deleted.

Step 2.3: Add one accelerometer location from the remaining candidate locations to the existing sensor placement each time. Calculate the MAC matrix of the displacement mode shapes for the sensor placement after adding one position. Calculate all the situations, and then select the accelerometer location that produces the smallest maximum non-diagonal MAC value.

Step 2.4: Check if there is still a candidate accelerometer location to be selected. If there is, go back to step 2.2; if not, go to the next step.

Step 2.5: Check the maximum non-diagonal MAC value corresponding to the selected sensor placement and the number of selected accelerometer locations. If the maximum non-diagonal MAC value is less than 0.2, return to Step 2.1 and reduce the redundancy threshold value h. If the condition is not met, the S2 accelerometer position is finally selected according to the maximum non-diagonal MAC value.

Step 2.6: The S1 strain gauges determined by the strain gauge selection process and the S2 accelerometers determined by the accelerometer selection process together form the final sensor placement.

The beneficial effects of the present invention are as follows: The dual target sensor placement method proposed by this invention can monitor the strain information at the large deformation positions of the structure, and can obtain the global displacement modal information of the structure for modal analysis. The strain data can be fully utilized by the proposed sensor placement method. The strain data can monitor the large structural deformations, and can also be used to estimate the displacement mode shapes at other node positions. In addition, the placement of the accelerometers makes the obtained displacement mode shapes have good distinguishability and low information redundancy. Through this sensor placement method, the quantity of the local deformation information and the global displacement modal information obtained from the measured data, are guaranteed.

### DESCRIPTION OF DRAWINGS

FIG. 1 is the bridge benchmark model.

FIG. 2 shows the placement of strain gauges and accelerometers.

### DETAILED DESCRIPTION

The present invention is further described below in combination with the technical solution.

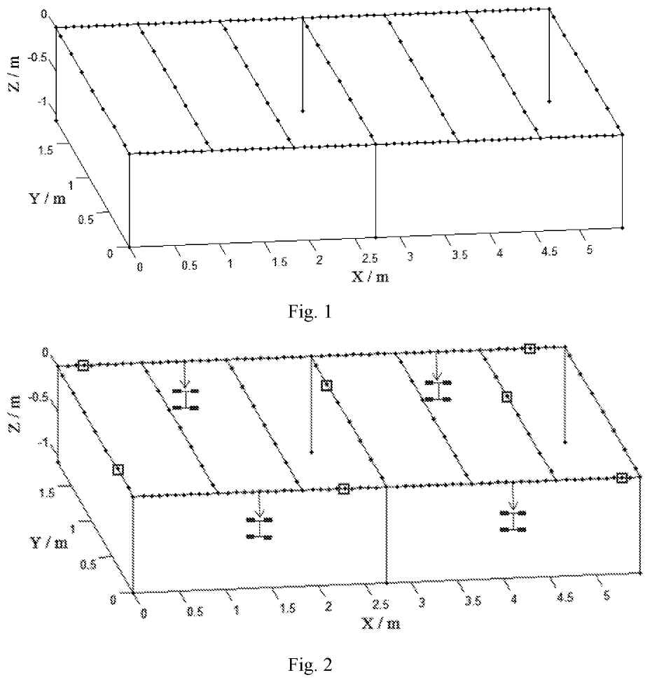

The method was verified using a bridge benchmark model. FIG. 1 shows the finite element model of the bridge benchmark structure. There are 177 nodes in total, in which each node has six degrees of freedom. The Euler beam element model is used to simulate the structure, and the cross sections have the same form of S 3×5.7 . After the relationship between the strain mode and the displacement mode is determined, the sensor placement method of arranging the strain gauges and the accelerometers proposed by the present invention can be used.

The first step uses the strain gauges selection steps in the invention to determine the positions of the strain gauge: firstly, the four mid-span cross-sectional positions on the main beams are selected to arrange the strain gauges; then, the transformation matrix of the strain mode and the displacement mode is utilized to adjust the positions of the strain gauges; finally, a total of 16 strain gauges are arranged at the four corners of the four mid-sections. These positions correspond to the large deformation positions of the structure, and also ensure that these positions contain as much displacement mode information as possible.

The second step uses the accelerometers selection steps in the invention to select the positions of the accelerometers. After several calculations, it was finally determined that the redundancy threshold h was 0.5, and a total of 7 accelerometer positions were selected to ensure that the MACₘₐₓ value was as small as possible.

FIG. 2 shows the results of the final sensor placement of 7 accelerometers and 16 strain gauges, where the squares represent the positions of the accelerometer locations and the positions of the strain gauges on the I-beam section are indicated by solid rectangles.

We claims:

1. A sensor placement method for capturing structural local deformation and global modal information, wherein the steps are as follows:
step 1: according to the finite element method, a structure is divided into individual elements, and elements and nodes are numbered; sections with large structural deformations are selected as candidate positions of strain gauges; for the ith element, a relationship between strain mode shape and nodal displacement mode shape is obtained;
φᵢ=Tᵢϕᵢ (1)
where: subscript i indicates number of the element; φᵢ is the strain mode shape matrix corresponding to the strain gauge locations in the ith element; ϕᵢ is a nodal displacement mode shape matrix of the ith element; Tᵢ is a translation matrix which represents the relationship between the strain mode shape and the nodal displacement mode shape in the ith element;
each row of Tᵢ corresponds to one row of the strain mode shape matrix, which corresponds to a strain gauge location; each column of Tᵢ corresponds to one row of the displacement mode shape matrix, which corresponds to one degree of freedom of the nodal displacement;
step 2: according to the element number of the strain section positions obtained in step 1, the value of each variable in the matrix T is checked according to Eq. (1); if the variable value is too small, fine tune strain position to include as much displacement modal information as possible;
from Eq. (1), the relationship between the strain mode shapes at all strain gauge locations in the structure and the displacement mode shapes at all nodes of the finite model can be derived;
φ=Tϕ (2)
where φ is a strain mode shape matrix of the strain gauge locations; ϕ is a nodal displacement mode shape matrix of the structure according to the FE model; T is a transformation matrix;
strain mode shapes corresponding to the strain gauge locations can be calculated from strain data; due to the limitation of the number of strain gauges, the number of rows of φ is smaller than the number of rows of ϕ, so that it is not feasible to directly estimate the displacement mode shapes of all nodes by the strain mode shapes; at this time, only the displacement mode shapes of some nodes can be estimated; here, ϕ^{r} is the displacement mode shape matrix which can be estimated, with r representing the degrees of freedom corresponding to the selected displacement mode shapes;
step 3: Eq. (2) can be further written as:
φ=T^{r}ϕ^{r}+T^{n-r}ϕ^{n-r} (3)
where: Tr represents r columns of T corresponding to the selected displacement mode shapes; T^{n-r} consists of remaining n−r columns of T; ϕ^{n-r} consists of remaining n−r rows of ϕ; n represents the number of the rows of ϕ, which is also the number of the columns of T;
in actual engineering, the strain mode shapes calculated by the strain data sometimes differ from the actual strain mode shapes of the structure, that is, there is a certain error; the source of error is mainly indicated by the measurement noise and the structural model error; thus, Eq. (3) can be further written as:
φ=T^{r}ϕ^{r}+T^{n-r}ϕ^{n-r}+w (4)
where: w represents error, which is expressed as stationary Gaussian noise, in which each column of w is also a stationary Gaussian vector w₍ᵢ₎; w₍ᵢ₎ has a mean of zero, and the covariance matrix is Cov(w₍ᵢ₎)=σᵢI, in which I is the unit matrix;
step 4: when the number of rows of T^{r} is greater than the number of columns of T^{r}, the multiplicative multiple least squares method can be used to estimate the displacement mode shapes (ϕ^{r});
\tilde{ϕ}^{r}=(T^{r}T^{r})⁻¹T^{rT}(φ−T^{n-r}ϕ^{n-r}) (5)
where: \tilde{ϕ}^{r} is the estimation result of ϕ^{r};
each column of \tilde{ϕ}^{r} can be expressed as:
\tilde{ϕ}₍ᵢ₎^{r}=(T^{r}T^{r})⁻¹T^{rT}(φ₍ᵢ₎−T^{n-r}ϕ₍ᵢ₎^{n-r}) (6)
where: the subscript i indicates the ith column of the corresponding matrix;
from Eq. (6), the covariance matrix of \tilde{ϕ}₍ᵢ₎^{r} can be written as:
Cov(\tilde{ϕ}₍ᵢ₎^{r)=σ}ᵢ²(T^{rT}T^{r})⁻¹ (7)
where: Cov(\tilde{ϕ}₍ᵢ₎^{r}) represents the covariance matrix;
step 5: the trace of the covariance matrix Cov(\tilde{ϕ}₍ᵢ₎^{r}) can be used to represent the magnitude of the estimation error;
error (\tilde{ϕ}₍ᵢ₎^{r})=σᵢtrace({square root over (T^{rT}T^{r})⁻¹)} (8)
where: error(\tilde{ϕ}₍ᵢ₎^{r}) represents the estimation error of \tilde{ϕ}₍ᵢ₎^{r};
then, the estimation error of \tilde{ϕ}^{r} consists of the estimation errors of different columns of \tilde{ϕ}^{r};
$$error ( {\tilde{Φ}}^{r} ) = {\sum }_{i = 1}^{N} {σ}_{i} trace ( \sqrt{{( {T}^{rT} {T}^{r} )}^{- 1}} ) \qquad ( 9 )$$
where: N is the number of the columns of \tilde{ϕ}^{r}, which is also the number of the mode orders;
when σᵢ of different mode orders have the same value, the Eq. (9) can be further written as:
error(\tilde{ϕ}^{r})∝trace({square root over (T^{rT}T^{r})⁻¹)}) (10)
it can be seen from Eq. (10) that the value of error(\tilde{ϕ}^{r}) is mainly determined by T^{r}; different transformation matrices T^{r} correspond to different locations of the estimated displacement mode shapes; finally, the T^{r} corresponding to the minimum estimation error is determined, and the displacement mode shapes of the locations corresponding to the determined T^{r} are estimated.
